(19) United States
(12) Patent Application Publication
(10) Pub. No.: US 2017/0180483 A1
(43) Pub. Date: Jun. 22, 2017

(54) Method And Apparatus For Facilitating Device-Management

(71) Applicants: Jigang Yang, Cedar Park, TX (US); Bahadir Danisik, Konya (TR)

(72) Inventors: Jigang Yang, Cedar Park, TX (US); Bahadir Danisik, Konya (TR)

(21) Appl. No.: 14/978,401

(22) Filed: Dec. 22, 2015

(51) Int. Cl. H04L 29/08; H04L 29/12; G06F 17/30

(52) U.S. Cl. CPC H04L 67/141; G06F 17/30575; H04L 61/6022; H04L 67/1095; H04L 67/1004

(57) ABSTRACT

Apparatus and methods for facilitating remote device management. A TRM server and affinity repository are provided, and preferably a plurality of TRM servers and a global synchronized affinity repository to avoid or reduce dependency for reliable affinity inquiries on the device management database. Active-active geo-redundancy enhancement is expected. The TRM server is configured to receive device connection initiations requests and, if necessary, calculate a device affinity and route the connection request to an appropriate device management server site accordingly.

### BACKGROUND

Field of the Disclosure

The present disclosure relates generally to network communications and, more particularly, to managing geo-redundancy in device management systems.

Description of the Related Art

The following abbreviations are herewith expanded, at least some of which are referred to within the following description.

API Application Programming Interface

CPE Customer Premises Equipment

CWMP CPE WAN Management Protocol

IEEE Institute of Electrical and Electronics Engineers

ITU International Telecommunication Union

MAC Media Access Control

NBI NorthBound Interface

OAM Operation, Administration and Maintenance

OSS Operation Support System

SBI SouthBound Interface

TR Technical Report [a Broadband Forum term]

TRM Traffic Regulation Module

WAN Wide Area Network

Many modern electronic devices, for example home-network routers or VoIP phones, can be managed remotely. Several advantages of this are apparent, for example subscribers do not have to bring the devices to a service center or attempt to perform upgrades on their own. A service technician visit is not required. In addition, updates may be made and some problems may be detected and taken care of without any customer involvement at all. Devices that can be remotely managed provide a convenience for all concerned.

There are many such devices, however, and the system required to manage them all is extensive. Device management servers are often clustered together at a site where they may be able to access a shared database and also share the device-management workload. A load balancer may be used to distribute the work efficiently. In a device management system, this configuration may be replicated at a number of different sites. In this case, global balancing may be performed so that device traffic to the device management system may be directed to an appropriate site (where a local balancer may then distribute the incoming traffic to one of the device management servers in the site cluster). The local databases may synchronize with those of other sites so that a device may be managed from more than one site.

This database synchronization may be important for redundancy. That is, the ability to manage a device from more than one site is useful in case its “normal” site goes down for scheduled maintenance or fails without warning. It may also be useful where a particular site is overwhelmed and traffic must be directed elsewhere to avoid undue delay. Having the ability to manage devices from different sites is sometimes referred to as geo-redundancy.

### SUMMARY OF EMBODIMENTS

The following presents a summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In some embodiments, a method provided for facilitating device management includes receiving a device management connection request from a device, determining if a device management affinity has been calculated for the device and if not, calculating a device management affinity. The method may further include storing any calculated device affinity, for example in a global affinity repository. The method may further include directing the communication from the device to a device management site, either according to a calculated affinity or one that has been previously stored in a global affinity repository.

The method in some embodiments may additionally include, if a device management affinity has been previously calculated for the device, determining the validity of the previous calculation and, if the previous calculation is determined to be not valid, calculating a new device affinity. The determination of the validity of the previous calculation may, for example, be based at least in part on whether one of more of any factors used to perform the previous affinity calculation are currently correct, the amount of time that has passed since the previous calculation. The affinity calculation itself may, for example, be based one or more of the geographic location of the device, an identity number associated with the device, or a MAC or IP address.

In some embodiments, apparatus for facilitating device management includes a TRM server, which in turn includes a processor, a memory device in communication with the processor, an affinity calculator for calculating a device management affinity, and a network interface in communication with the processor. The affinity calculator may, for example, be implemented at least in part by execution of program instructions stored on the memory device according to affinity rules stored on or available to the TRM.

In some embodiments the apparatus may also include a repository stored on a memory device in communication with the TRM server. In preferred embodiments the repository is a global affinity repository stored on one or more memory devices. The apparatus may also in some embodiments include a load balancer for distributing received device management connection requests to selected ones of the plurality of TRM servers.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram illustrating a device management system according to some embodiments;

FIG. 2 is a flow diagram illustrating a method for facilitating device management according to some embodiments;

FIG. 3 is an annotated block diagram illustrating a device management system according to some embodiments; and

FIG. 4 is a block diagram illustrating selected components of a TRM server according to some embodiments.

### DETAILED DESCRIPTION

Geo-redundancy for device management server-cluster sites has apparent advantages. Having multiple sites allows one to handle some or all of the work of another should the need arise. Geographic diversity also allows for some sites to be physically closer to the devices they manage, should that proximity be an advantage, and also to allow in some cases for peak load related balancing. It also helps to prevent the same adverse event, for example a hurricane or snowstorm, from affecting operation of multiple sites. Note however, that no degree of physical separation is required, and so the term “geo-redundancy” as used herein refers only to a separate site regardless of its distance from other sites.

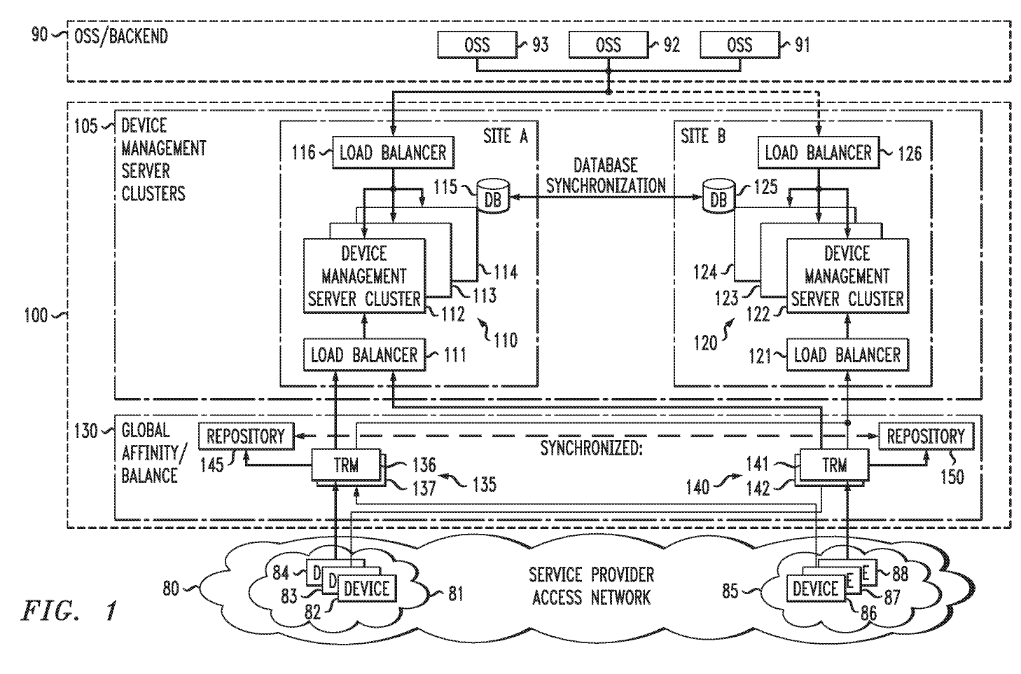

FIG. 1 is a block diagram illustrating a device management system 100 according to some embodiments. In this embodiment, device management system 100 includes a site-server system 105 and a global affinity system 130. The site-server system 105 includes one or more device management server sites; depicted in FIG. 1 are server site A and server site B. Although only two server sites are shown in FIG. 1, however, in actual implementations there may be many more. Note that while sites A and B are in FIG. 1 illustrated identically, there is no requirement that they be exactly the same. As mentioned above, the different sites may be separated geographically.

In this embodiment, site-server system 105 is in communication various OSS (operations system support) 90. This general reference in FIG. 1 includes OSSs 91, 92, and 93 as an illustration. An individual OSS may be, for example, a service provider's backend system, a service representative application, or any other application that needs to be integrated with the device management site-server system 105. The integration of an OSS 91, 92, 93 with the site server system 105 may be effected, for example, using API (application program interface) calls over what is commonly referred to as the NBI (northbound interface).

Note that for convenience, the physical layer connections in FIG. 1 are simplified. The various connections may involve, for example, a service provider's core network, a service provider's access network, or the Internet.

In the embodiment of FIG. 1, managed devices in a service provider network 80 are for illustrative purposes grouped into two locales 81 and 85. The managed devices, also sometimes referred to as UE (user equipment) or CPE (customer premises equipment) depending on the context, are being or may be managed by device management site-server system 105 over what is sometimes referred to as a southbound interface. In FIG. 1, devices 82, 83, and 84 are shown in locale 81 and devices 86, 87, and 88 are shown in locale 85. Of course, in practice there will be a great many such devices, which are variously distributed and may or may not be physically or logically grouped in this fashion. The managed devices of service provider network 80 communicate with the device management site server system 105 or what is sometimes referred to as an SBI (southbound interface). Again, the paths of communication in FIG. 1 are simplified for clarity.

In this embodiment, server sites A and B include, respectively, include server clusters 110 and 120. Each server cluster is shown here with three device management servers. Cluster 110 includes device management servers 112, 113, and 114. Cluster 120 includes device management servers 122, 123 and 124. The number of servers is illustrative, in actual implementation there may be a different number, and the number is subject to change over time. Memory devices 115 and 125 store at least a device management database populated with information relating to managed devices and the management of them, for example their identity and the status of any previously-performed or pending upgrades. Load balancers 116 and 126 balance incoming NBI communications from OSSs 90, that is communications are assigned to a particular server in the respective server cluster 110, 120 so that no one server in the cluster is over- or under-utilized. Load balancers 111 and 121 perform essentially the same function for SBI communications.

In the embodiment of FIG. 1, device management system 100 also includes a global affinity system 130. The affinity system includes at least one TRM (traffic regulation module server. Preferred embodiments include more than one so that the TRMs can be distributed geographically or logically or both. In the embodiment of FIG. 1, two TRM clusters 135 and 140 include TRMs 136, 137 and 141, 142, respectively. Each TRM cluster may be situated relatively close a group of managed devices in a given locale, or to a device management server site, or both, although this is not the case in all implementations.

In the embodiment of FIG. 1, each TRM cluster 135, 140 is associated with a memory device 145, 150, respectively. Each memory device 145, 150 includes at least a repository populated with affinity information for managed devices. The affinity information includes at least the identity of mobile devices a device-management server site with which they are currently associated. The repositories are continually or at least frequently synchronized. This may be done as frequently as sending notification relating to every affinity determination or at intervals. These intervals may be strictly periodic or may vary upon traffic levels or other factors. For example if a device management server site experiences problems, the frequency of synchronization events may be increased. Finally, it is noted that the device management system may be but is not necessarily based on an IP-based protocol such as the TR-069 CWMP protocol.

Note that FIG. 1 illustrates an exemplary configuration and different implementations may vary in the number or arrangement of the various components. In some cases components separate in FIG. 1 may be integrated with other components. At times a component may be divided into more than one physical device. The operation of the systems of FIG. 1 will now be described in more detail.

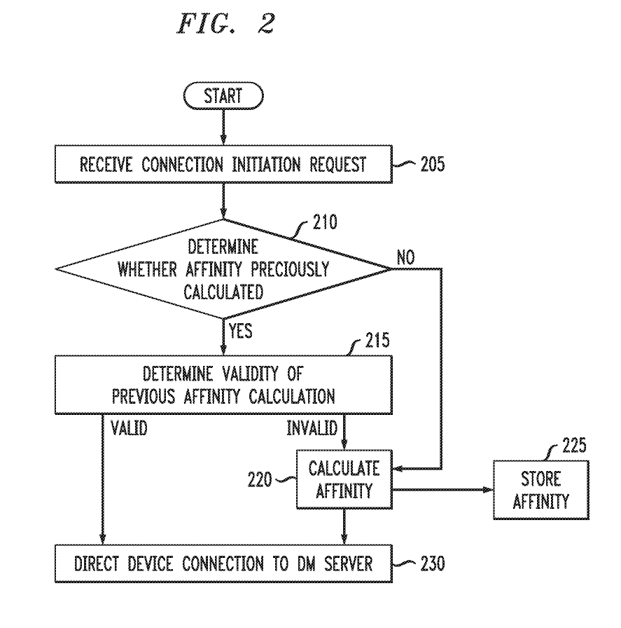

FIG. 2 is a flow diagram illustrating a method 200 for facilitating device management according to some embodiments. At START it is presumed that the components for performing the method are available and configured for operation at least according to this embodiment. The process then begins when a device management connection initiation request is received (step 205) at a TRM server. The connection initiation request is in most if not all cases a message sent from a device to the device management system in order to establish a connection to, for example, report status or receive an update. The initiation request may in many cases arrive at a central location and be delivered to an available TRM.

In any event, in this embodiment, the TRM receiving the connection initiation request then determines (step 210) if an affinity calculation for the device has been previously performed. In most cases this involves checking the global affinity repository, where the results of a previous calculation would be stored. It is noted that if an affinity calculation had previously been performed for the device but the result had been deleted as aged or for some reason storage had not been successful, a negative determination usually results at step 210. On the other hand, if an affinity for the device had been previously assigned (rather than calculated) and stored in the global affinity repository, a positive decision at step 210 will typically result.

In the embodiment of FIG. 2, if there is a positive determination at step 210, the TRM server determines (step 215) whether the previous affinity calculation is still valid. This determination may vary by implementation. In some embodiments, the previous calculation is always considered valid (presumably unless, for example, it points to a device management server site that no longer exists or similar circumstance). A particular stored affinity could also be marked as “permanently” valid even if all such records are not so considered. An assigned affinity may be marked in this manner.

In some embodiments, affinity validity may be determined by evaluating the condition or conditions that supported the previous affinity calculations. For example, if the current geographic location of the device differs from the location used in the previous calculation, then the determination at step 215 may find that previously-stored affinity is no longer valid. In some embodiments, an affinity may be considered invalid if the calculation was performed too long ago (a length of time that may vary by implementation).

In the embodiment of FIG. 2, if no previous affinity was calculated or if the stored affinity is not considered valid, then the TRM server calculates (step 220) the device management affinity for the device sending the initiation request. Calculating the device's affinity is a decision about which device management server site is preferred for performing the device management task. This determination is normally made according to a defined set of rules stored on or available to the TRM server.

In one embodiment, for example, the determination is made according to the device's geographic location. This location may be included in the initiation request, for example, or may be obtained by a query to the initiating device, if possible. The location may also by inferable from other information provided by the initiation request. In other embodiments, the affinity may determined by the device's serial number or other identifying information, which may also in some cases provide some indication of geographic location. In yet other embodiments, an address associated with the device, such a based device hardware MAC address or an IP address associated with the initiation request.

In the embodiment of FIG. 2, when the affinity has been calculated at step 220, the affinity determination is stored (step 225) in the global affinity repository. As implied above, this may be done by storing the affinity determination in a repository associated with the TRM server as the individual repositories are frequently synchronized. In another embodiment, the TRM server storing the affinity determination may store it on each known repository device, presuming that is permitted in a particular implementation.

In the embodiment of FIG. 2, the TRM server then directs (step 230) the device connection to the appropriate device management server site so that the device management process may be executed.

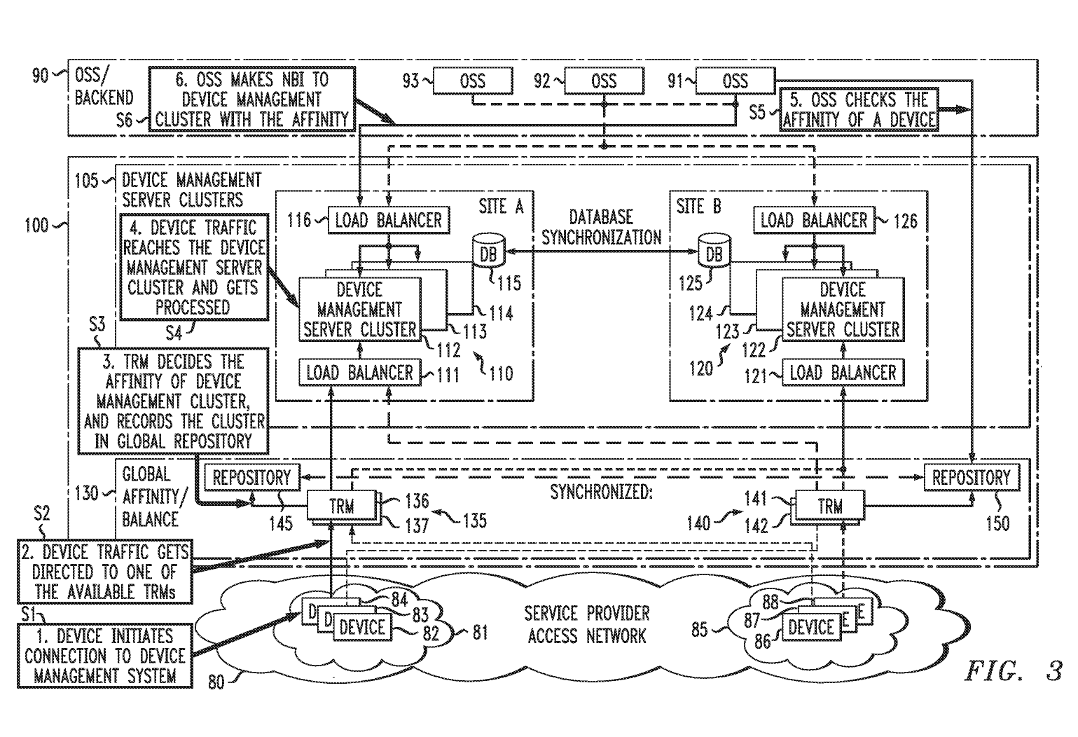

FIG. 3 is an annotated block diagram illustrating a device management system 100 according to some embodiments. As should be apparent, FIG. 3 is similar or identical to the system depicted in FIG. 1, and the various illustrated components are described above. This is not meant to imply, however, that the configuration may not vary in other implementations. It is further noted that FIG. 3 illustrates a method that is similar but not identical to that shown in FIG. 2.

In the embodiment of FIG. 3, a managed device initiates a connection to the device management system (step S1). Note that as used herein, a “managed device” connotes one that will or may be managed by the device system, or that has been managed by the device management system in the past, in addition to describing a device that is current undergoing some management process. In doing so, the device uses an address pointed to the global affinity system 130, where the device traffic is directed to an available TRM server (step S2).

In this embodiment, the selected TRM then determines the affinity of the device and the device management server cluster or site and directs the connection there, storing the affinity in the global repository (step S3). At the device management server site a load balancer selects the device management server for processing, that is, performing or at least initiating whatever management task is appropriate in the situation.

In the embodiment of FIG. 3, it is presumed that a backend system of some kind, such as an OSS, seeks to influence the management of a device. For purposes of illustration, in FIG. 3 is presumed to be the device that in initiated the connection request at step S1. Note, however, that the OSS need not be, and frequently is not, reacting directly (or even indirectly) to the connection request. However motivated, the OSS first checks the global affinity system to determine the affinity of the device (step S5). Armed with that information, the OSS then directs its instructions to the device management server site or cluster having affinity with the device (step S6).

Here it is noted that as illustrated in FIG. 3 (and FIG. 1), the device management databases of site-server system 105 synchronize with each other, supporting redundancy and management system resilience. This process, however, typically involves replication the transfer of large amounts of data, which takes time and is subject to delays due to, for example, heavy traffic or buggy devices. These and other problems associated with the process can cause unpredictable high replication lag. As applied to the embodiments of FIG. 3, a device management operation started from one device management server site may not be available to another site that has been contacted by the managed device. Using the TRM servers and the global affinity repository as described herein, however, supports allowing device traffic to be forwarded to a device management site or cluster in a predictive manner. An advantage is expected where the global affinity repository is not dependent on the replication of data by the site databases.

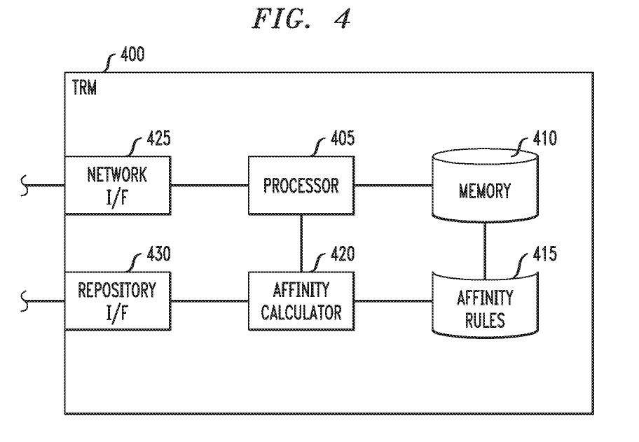

FIG. 4 is a block diagram illustrating selected components of a TRM server 400 according to some embodiments. In this embodiment, TRM 400 includes a processor 405 that directs operation of the separately shown affinity calculator 420, in some embodiments by executing programming instructions stored on memory device 410. Memory device may also store other instructions as well as data. In FIG. 4, the TRM server 400 also includes separately shown affinity rules 415, which affinity calculator may call when determining the affinity of a particular device. In this embodiment, TRM 400 also includes a network interface 425 for communication with other components of the device management system, managed devices, and in some cases backend systems as well. In FIG. 4, a separate repository interface 430 is shown, although in alternate embodiments it may be integrated with the network interface 425. Note that FIG. 4 illustrates an exemplary configuration and different implementations may vary in the number or arrangement of the various components. In some cases components separate in FIG. 4 may be integrated with other components. At times a component may be divided into more than one physical device.

In this manner, apparatus and methods are provided that facilitate device management and device management systems by, inter alia, providing a TRM server and affinity repository, and preferably a plurality of TRM servers and a global synchronized affinity repository to avoid or reduce dependency for reliable affinity inquiries on the device management database. Active-active geo-redundancy enhancement is expected.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the sequence in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method facilitating device management, comprising:
receiving a device management connection request from a device;
determining if a device management affinity has been calculated for the device;
calculating, if a device management affinity has not been calculated for the device, a device management affinity.

2. The method of claim 1, further comprising storing any calculated device affinity.

3. The method of claim 2, wherein the device affinity is stored in a global affinity repository.

4. The method of claim 1, further comprising directing the communication from the device to a device management site.

5. The method of claim 1, further comprising directing the communication from the device to a device management site according to a previously-stored affinity.

6. The method of claim 1, further comprising, if a device management affinity has been previously calculated for the device, determining the validity of the previous calculation and, if the previous calculation is determined to be not valid, calculating a new device affinity.

7. The method of claim 6, wherein the determination of the validity of the previous calculation is based at least in part on a determination of whether one or more of any factors used to perform the previous affinity calculation are currently correct.

8. The method of claim 6, wherein the determination of the validity of the affinity is based at least in part on the amount of time that has passed since the previous calculation.

9. The method of claim 1, wherein the device management affinity calculation is based at least in part on the geographic location of the device.

10. The method of claim 1, wherein the device management affinity calculation is based at least in part on a MAC address associated with the device.

11. The method of claim 1, wherein the device management affinity calculation is based at least in part on an identity number associated with the device.

12. Apparatus for facilitating device management comprising:
a TRM server, comprising:
a processor;
a memory device in communication with the processor;
an affinity calculator for calculating a device management affinity; and
a network interface in communication with the processor.

13. The apparatus of claim 12, wherein the affinity calculator is implemented at least in part by execution of program instructions stored on the memory device according to affinity rules.

14. The apparatus of claim 13, wherein the affinity rules are stored on the memory device.

15. The apparatus of claim 12, further comprising a repository stored on a memory device in communication with the TRM server.

16. The apparatus of claim 15 further comprising a global affinity repository in communication with a plurality of TRM servers.

17. The apparatus of claim 16, further comprising a load balancer for distributing received device management connection requests to selected ones of the plurality of TRM servers.

18. The apparatus of claim 16, further comprising a plurality of memory devices, each host the global affinity repository.

19. The apparatus of claim 18, wherein the global affinity repository is configured to synchronize between each of the plurality of memory devices.
